(19) United States
(12) Patent Application Publication
(10) Pub. No.: US 2012/0043223 A1
(43) Pub. Date: Feb. 23, 2012

(54) Water treatment method

(76) Inventor: David Sherzer, Omer (IL)

(21) Appl. No.: 12/858,899

(22) Filed: Aug. 18, 2010

(51) Int. Cl. C02F 1/461; C02F 1/44

(52) U.S. Cl. 205/742; 204/196.01

(57) ABSTRACT

For substantially eliminating scale buildup in a water processing facility, a water treatment method having the steps: accepting a scale formation standard value amount of scale formation that would occur in the facility from a cubic meter of water; measuring water from a water source for total hardness, alkali hardness, pH, and temperature; and therewith substantially removing a calculated scale removal target quantity from each cubic meter of the water source water just prior to entry of said water into the facility. Essentially, just prior to entry of each quantity of predetermined water into a water flow-through processing facility, removing more than about 0.1% of dissolved scale from the water quantity albeit less than 10% of dissolved scale from the water quantity.

### FIELD OF THE INVENTION

The present invention generally relates to a water treatment stage, such as sea water before a desalinization process or fresh water before a purification process. The present invention also relates to a method of comparing some measurements of input water to some measurements of the water processing in order to determine specification thresholds for a cost beneficial treatment process stage.

### BACKGROUND OF THE INVENTION

Treating water, for removing salts and other dissolved substances, is becoming more important and more widespread; as needs for low salt content water are growing around the globe. Desalinating sea water or brackish water to obtain fresh water for agriculture or human consumption, or purifying fresh water to obtain pure water for medical or clean industrial uses, are just a few examples.

When Reverse Osmosis (RO) is used in the purification process, treatment of the water is generally employed as a step prior to the RO, in an attempt to remove contaminants from the water that might otherwise foul and clog the RO membranes. One example of RO membranes clogging process is scale formation. Scale is formed on the RO membranes because scale constituents, typically Ca and CO₃, exceed their saturation levels in the concentrated stream which is ejected from the RO filter. Known methods used to diminish the scale formation problem include adding softeners to the water (e.g. Na in the form of NaCl or NaCO3) that bind to the scale constituents, or collecting scale constituents on sheets (e.g. Zeolites); both methods taking advantage of ion exchange processes.

Tonelli et. al. (U.S. Pat. No. 6,258,278) discloses a method of producing high purity water using dealkalization and a double-pass RO membrane system, having enhanced membrane life. The method includes five steps of pre-treating the water prior to the first RO step. Generally, in order to overcome the costly problem of clogging RO membranes, removal of scale constituents is employed to such an extent that the constituents concentration in the rejected concentrated stream during the RO step is below the saturation level, and is often close to zero and negligible (relative to the concentration in the un-treated water).

A second type of process that leads to RO membrane clogging is fouling with ferum present in dissolved form in the untreated water. Common method for dealing with the problem is by enriching the water with dissolved oxygen that binds with the Fe ions to produce hydrated iron oxides, followed by a sedimentation step or filtering the coagulated particles.

Yet another source of RO membrane clogging comes from biological material in the untreated water. When water carrying such bio-life is pressurized through the RO membranes, the concentrated biological material in the concentrated rejected stream, with some dissolved oxygen, tends to build up and clog the membranes.

Now, FIG. 1 shows a conventional RO unit 2, capable of pre-treating the water for scale, dissolved metals such as Ferum, and biological material. Raw water enters through an entrance 10 into a water tank 12. Water tank 12 is used to accumulate and store raw water flowing into the system together with excess water from other sources in the system, as is explained below. Water tank 12 can further be used for sedimentation of dissolved metals, e.g. iron, and for coagulation of suspended materials in the raw water.

From water tank 12, water is driven through by a pump 14 into a sand filter 16 which is used to capture rough particles and coagulated material. A pump 20 adds chlorine from a Cl tank 18 to the water exiting sand filter 16, to disinfect the water from bio-life material. An active carbon filter 22 is used to adsorb the chlorine from the water, to prevent possible adverse effect of the chlorine on the RO membranes (which are used further down the process). Some of the water exiting active-carbon filter 22 is driven back through a pipe 24 to water tank 12, to provide several cycles of filtration through filters 16 and 22, thus enhancing the filtration quality.

FIG. 1 displays two possible options for scale removal, in accordance with the description given above. According to Option 1, softening material (e.g. NaCl) from a tank 26 is added to the water in a pipe 30 by a pump 28. According to Option 2, the water goes through a water softener tank 34, which includes scale adsorbent (e.g. zeolite).

Water exiting the scale remover, either by Option 1 or by Option 2, enters a fine filter 36 (e.g. a 5 μm filter) to capture all particles that otherwise might clog the RO membranes (having a typical inter distance between adjacent membranes of 10 μm). An RO pump 38 drives the water at high pressure into an RO filter 40, wherefrom pure water exit through a flow-meter 46 into an RO water tank 48. Rejected water exit RO filter 40, part of which exits the system into the drain through a flow-meter 44, and the remaining part is returned back into the RO cycle through a flow-meter 42. Flow-meters 42, 44 and 46 may be used for monitoring the RO process by measuring the flow rates at its entrance and exits.

From RO water tank 48 water is cycled through a UV radiation unit 54 by a pump 52, to provide an additional sanitization to the water prior to exiting the system through an exit 50. Excess water in RO water tank 48 flows back to water tank 12 through pipe 56 to be circulated over again through the system.

It should be noted that there are many patents in this area which each respectively seeks to improve on the prior arts of water processing; particularly for RO processing. Some interesting US patent examples are: U.S. Pat. Nos. 6,332,960; 6,607,668; 6,649,037; 7,374,655; 7,381,328; 7,578,919; and their respective prior art citations. From an ordinary review of these patents, the reader will better appreciate some aspects of the empirical novelty of an alternative solution (such as will be described in detail with respect to the instant invention).

Now, there remains a longstanding need in the field of water processing, cost reduction methods; wherein those methods do not reduce the water quality of the end product. Furthermore, in the examples of RO, there is a longstanding need to use efficient separation membranes for as long as possible. In addition, for other water circulation or processing systems, such as cooling towers or heating systems or the likes, there remains a longstanding need to reduce scale accumulation; because scale accumulation reduces the useful and/or operational life of such systems.

### SUMMARY OF THE INVENTION

The present invention relates to embodiments of a water treatment method, for substantially eliminating scale buildup in a water processing facility, the method comprising the steps: (I) accepting a scale formation standard value (S) g/M3 as an amount of scale formation that would occur in the water processing facility from a cubic meter of water having 360 ppm total hardness and 250 ppm alkali hardness and 7.5 pH and at 25 degrees Celsius, wherein said facility is operating at a normalized water throughput condition; (II) measuring water from a water source for total hardness (H) ppm, alkali hardness (A) ppm, pH (P), and temperature (C) Celsius; (III) calculating a scale removal target (R) using a formula R=10*S*[1+((H−360)/360)+((A−250)/250)+((P−7.5)/7.5)+((C−25)/25)], wherein said facility is sized as proportional to operating at the normalized water throughput condition; and (IV) substantially removing a quantity of about R scale from each cubic meter of the water source water just prior to entry of said water into the water processing facility.

In the context of the present invention “scale” is essentially material which leaves a water solution to clog membranes and pipes; substantially identical to the complex technical formulas of water engineers whereby total scale is a factor derived from known complex formula multiplied by (total hardness+alkaline hardness). Total hardness is substantially dissolved calcium; while alkali hardness is substantially dissolved carbonates. Thus, for many applications, measuring total hardness is essentially measuring dissolved calcium, while measuring alkali hardness is essentially measuring dissolved carbonates. It is beyond the scope of this invention to teach the complexities of actual total hardness and actual alkali hardness chemistry because most typical professional water engineers already know the significant aspects of other substances which contribute to actual total hardness and actual alkali hardness. Also, please note, that in the present invention, the notation “M3” is the unit “cubic meter”.

Now, embodiments of the present invention are based on a number of empirical observations (by the instant inventor) relating to scale buildup in commercial water treatment facilities. In this context, typical facilities may include those performing processes of Reverse Osmosis, Water Heating, Water Cooling, and the likes. The observation, per se, is that removing a relatively small portion of the dissolved scale from the water just prior to said water's entry into one of these facilities results in the essential lack of accumulation of scale in that system by that water.

While it is the purpose of this invention to teach practical embodiments and it is not the purpose of this invention to present a new theory of water chemistry, nevertheless the observed “no accumulating scale” phenomena deserves a moment of speculation; especially since this may help the reader to apply the non-limiting exemplary embodiments of the present invention to water processing facilities of increasing dissimilarity.

Conceptually then, it appears that water chemistry has very complex dynamics, and this in turn means that there is a latency (time delay) for chemically perturbed water to produce a scale accumulation response in a typical water processing facility. Knowing the length of time that a sample volume of water will be in the facility and knowing some fundamental factors concerning that water and about that facility will allow the engineer to establish an appropriate degree of perturbation for the water just before said water enters the facility; which in turn will result in failure of that water to leave scale in the facility.

However, it seems that there are other more complex aspects to the latency of water dynamics, which in turn might result in other physical chemistry “pathways” for causing scale formation in the facility; and this causes us to restrict our expectation for this new found phenomena of water dynamics to from about R/2 to about 5R which is an order of magnitude about the scale removal target (R), or to (B) more than about 0.1% of the dissolved scale albeit less than 10% of the dissolved scale.

The present invention generally relates to embodiments of a water treatment method, which may be better understood in conjunction with FIG. 2, the method comprising the steps: (I) accepting a scale formation standard value—which need only be modified when there is a change in the operating parameters of the water processing facility (such as water velocity of throughput); (II) measuring water from a water source—which need only be repeated according to changes in the water source (such as change in temperature or seasonal change in level of dissolved constituents, etc.); (III) calculating a scale removal target (R)—which need only be recalculated according to changes in the water measurement; and (IV) substantially removing a quantity of about R scale from each cubic meter of the water source water just prior to entry of said water into the water processing facility—which may occasionally generate a feedback evaluation (such as sudden appearance of some scale formation in the facility or immediately at the water exit from the facility) which in turn would cause a need to reassess at least one of the previous steps—in the context of a continuously operating water processing facility.

Now, turning to step (I) (FIG. 2—2100), accepting a scale formation standard value (S) g/M3 as an amount of scale formation that would occur in the water processing facility from a cubic meter of water having 360 ppm total hardness and 250 ppm alkali hardness and 7.5 pH and at 25 degrees Celsius, wherein said facility is operating at a normalized water throughput condition—relates to a specific expectation value for scale that would form in a standard operating condition processing facility of this kind. For example, if the diameter of pipes or the water velocity for the processing facility differs from an empirical standard, then the value (S) must be modified accordingly. Essentially, for a calibration cubic meter of water having 360 ppm total hardness and 250 ppm alkali hardness and 7.5 pH and at 25 degrees Celsius, there is an empirical expectation of how much scale will accumulate within the facility. For existing water engineers, this is a know quantity, from the facility de-scaling (e.g. cleaning) program that would be employed if untreated standard calibration water were used. For most actual operating water treatment facilities, this value is not empirically known, because the operating engineer will already begin operating the facility with assumptions about pretreatment of the water to optimize the maintenance costs with respect to the operating efficiency, yield, and operating costs.

Now, turning to step (II) (FIG. 2—2200), measuring water from a water source for total hardness (H) ppm, alkali hardness (A) ppm, pH (P), and temperature (C) Celsius; and ordinary measurement techniques are employed to acquire these values. In this context, the water source measurement is for the water just prior to entry into the water processing facility.

Now, turning to step (III) (FIG. 2—2300), calculating a scale removal target (R) using a formula R=10*S*[1+((H−360)/360)+((A−250)/250)+((P−7.5)/7.5)+((C−25)/25)], wherein said facility is sized as proportional to operating at the normalized water throughput condition; and the formula accumulates the proportional differences between the water source and the water calibration standard [((H−360)/360)+((A−250)/250)+((P−7.5)/7.5)+((C−25)/25)]—which is then added to unity (1) and multiplied by one order of magnitude times the scale formation expectation value (10*S). Here the ordinary professional knowledge of the water engineer must re-size the formula according to the difference between the actual water processing facility and the water processing facility that was used to provide the scale formation expectation value (S). Examples for reverse osmosis water treatment facilities, water cooling treatment facilities, and water heating treatment facilities are provided in greater detail below and in the detailed description section. Nevertheless, there will always be water treatment facilities for which an appropriate scale formation expectation value will have to be determined—and this determination may require some experimentation to collect some actual data. The essence of the instant invention lies in the fact that the scale removal target (R) is significantly smaller than any heretofore suggested in prior art, therefore we posit that this degree of novelty may reasonably call for sometimes measuring quantitative values that have not yet been formalized in the standard water engineering handbook.

Now, turning to step (IV) (FIG. 2—2400), substantially removing a quantity of about R scale from each cubic meter of the water source water just prior to entry of said water into the water processing facility. Now, as mentioned above, a quantity of about R is either (A) from about R/2 to about 5R which is an order of magnitude about the scale removal target (R), or to (B) from more than about 0.1% of the dissolved scale to less than 10% of the dissolved scale.

According to a first significant embodiment of the present invention, accepting includes that the scale formation standard value (S) is 0.2 g/M3, and calculating includes that the water processing facility is a Reverse Osmosis (“RO”) process, the normalized water throughput condition is a water velocity of 1.5 meters per second through 1 meter long osmotic pressure separation tubes respectively of 4 inch diameter. These aspects constitute the standardized base values for the instant invention, and deviations therefrom must be properly compensated for. Today, the well known commercial RO water treatment membranes vendors in the market are: DOW, HYDRANAUTICS, CSM, KOCH, TORAY, DESAL. As further progress will occur in the field of RO membranes, there will also emerge further appreciation of how to re-size aspects of the present invention to best suit that progress. This includes aspects like longer tubes, tubes of other diameters, changes in water velocity, and the likes.

According to a second significant embodiment of the present invention, accepting includes that the scale formation standard value (S) is 0.3 g/M3, and calculating includes that the water processing facility is a Water Cooling process, the normalized water throughput condition is 300 tons of refrigeration cooling capacity having a 150 M3/hour circulation to achieve a 5 Celsius degree temperature difference. These aspects constitute the standardized base values for the instant invention, and deviations therefrom must be properly compensated for. Just as there will be advances and variation in the field of RO, likewise similar developments are expected with respect to water cooling processes; for example, there may be peculiar or exotic additives to the water to improve the cooling functionality.

According to a third significant embodiment of the present invention, accepting includes that the scale formation standard value (S) is 0.5 g/M3, and calculating includes that the water processing facility is a Water Heating process, the normalized water throughput condition is 300,000 Kilo-calories/kg heat capacity for a heating temperature input of 60 Celsius degrees through a hot-water pipe of 3 inch diameter. These aspects constitute the standardized base values for the instant invention, and deviations therefrom must be properly compensated for. What has been stated for RO and water cooling processes is likewise substantially correct for water heating processes.

According to another embodiment of the present invention, removing a quantity of about R scale from each cubic meter of water includes that removing some bio-life using activated chloride is substituted for removing a functionally equivalent part of the R scale. Furthermore, according to a still another embodiment of the present invention, removing a quantity of about R scale from each cubic meter of water includes that removing some dissolved metals is substituted for removing a functionally equivalent part of the R scale.

Turning to yet another embodiment of the present invention, removing a quantity of about R scale from each cubic meter of water is by electrolysis. Nevertheless, there may be complementary treatment processes, such as changing temperature or changing pH, which in turn will modify the optimal R and actual R to be removed.

Now, the present invention also relates to embodiments of a water treatment method substantially as herein described and illustrated and characterized by, just prior to entry of each predetermined quantity of water into a commercial water flow-through processing facility, removing more than about 0.1% of dissolved scale from the water quantity albeit less than 10% of dissolved scale from the water quantity; thereby substantially eliminating scale buildup in the water processing facility.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the above summary and to the following description in consideration of the accompanying drawings, wherein:

FIG. 1 illustrates a schematic view of a conventional Reverse Osmosis unit;

FIG. 2 illustrates a schematic view of a basic embodiment of the instant invention;

FIG. 3 illustrates a schematic view of a water processing system according to some embodiments of the instant invention;

FIG. 4 illustrates a schematic view of another water processing system according to some embodiments of the instant invention; and

FIG. 5 illustrates a chart displaying the dependency of scale formation.

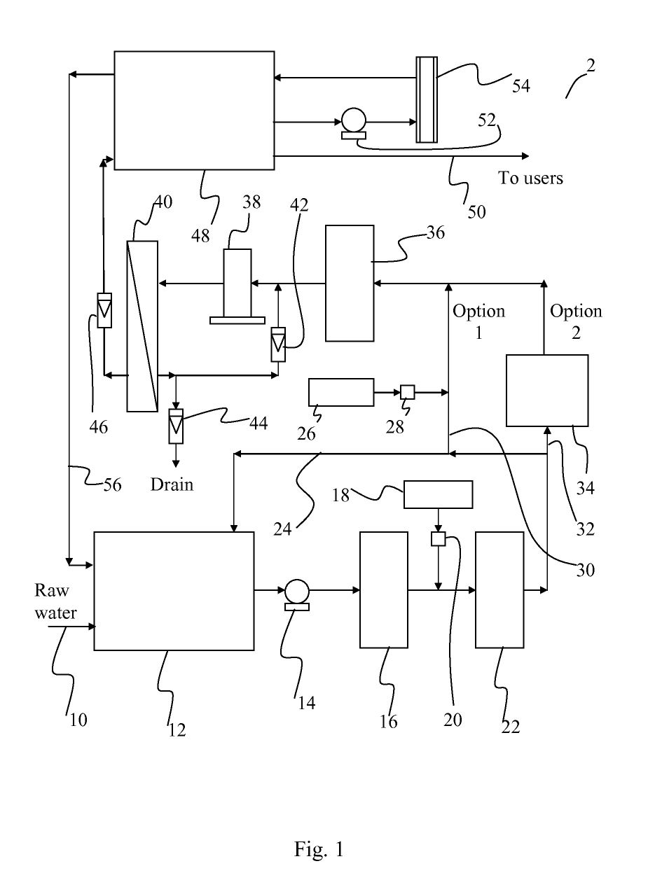

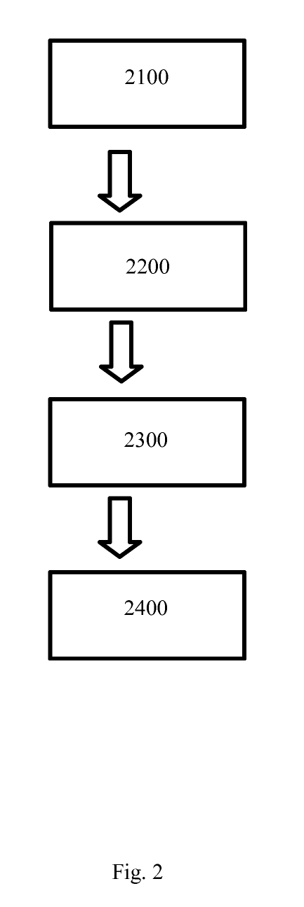

### DETAILED DESCRIPTION OF THE INVENTION

The underlying idea in some embodiments of the present invention is that pre-treating the water in an early step or treating the water as a side stream in the water circuit in the purification process, for removing only a portion—typically a small portion—of the dissolved constituents of scale, eliminates the formation of scale in subsequent units and filters in the process, and particularly in the RO step. In some embodiments the amounts of scale constituents after removing said portion in the treatment step, is higher than their respective saturation levels. Nevertheless, scale is substantially prevented, due to the removal of said portion.

Table 1 below presents three detailed examples for employing calculation of a target value R representing a quantity of scale to be removed. In all three examples, a water processing facility is assumed characterized with a scale formation expectation value S=0.2 gr/M3. Column B in the table shows example 1 representing raw water being water calibration standard and having total hardness H=360 PPM (as is shown in column B, row 1), alkalinity hardness A=250 PPM (column B, row 3), pH P=7.5 (column B, row 5) and temperature T=25 deg. C. (column B, row 7). Row 2 show the percentage of the value in row 1 (total hardness) with respect to the calibration standard, which is obviously 100 in example 1. Analogously, rows 4, 6 and 8, show the percentage of the values in rows 3 (alkalinity hardness), 5 (pH) and 7 (temperature), respectively, relative to their calibration standard values, and are all 100 as well. Row 9 shows the accumulated difference, in percent, of the values of the physical properties stated above, namely 360 ppm total hardness and 250 ppm alkali hardness and 7.5 pH and 25 degrees Celsius, from their respective values of the calibration standard, which totals to 0. Row 10 shows the consequent expectation value for the amount of scale formation that would occur in the water processing facility from a cubic meter of water having the physical properties stated above, namely 360 ppm total hardness and 250 ppm alkali hardness and 7.5 pH and at 25 degrees Celsius, wherein said facility is operating at a normalized water throughput condition, which is for Example 1 the value of S=0.2 gr/M3. The last row, row 11, shows the consequent result of the target value, which is R=10*S=2 gr/M3.

Column C of Table 1 shows example 2, representing raw water having total hardness H=420 PPM (as is shown in column C, row 1), alkalinity hardness A=300 PPM (column C, row 3), pH P=8 (column C, row 5) and temperature T=30 deg (column C, row 7). Rows 2, 4, 6 and 8 of column C show the respective percentage of the values in rows 1, 3, 5, and 7 relative to their calibration standard, which are 116.7%, 120%, 106.7% and 120, respectively. Row 9 shows the accumulated difference from the calibration standard, which adds up to 63.4%. Row 10 shows the consequent expectation value for the amount of scale formation that would occur in the water processing facility from a cubic meter of water having the physical properties stated above, namely 420 ppm total hardness and 300 ppm alkali hardness and 8 pH and 30 degrees Celsius, wherein said facility is operating at a normalized water throughput condition, which is for Example 2 the value of 0.2*1.634=0.327 gr/M3. The last row in column C, row 11, shows the consequent result of the target value, which is R=10*0.327=3.27 gr/M3.

Column D of Table 1 shows example 3, representing raw water having total hardness H=300 PPM (as is shown in column D, row 1), alkalinity hardness A=200 PPM (column D, row 3), pH P=7 (column D, row 5) and temperature T=20 deg (column D, row 7). Rows 2, 4, 6 and 8 of column D show the respective percentage of the values in rows 1, 3, 5, and 7 relative to their calibration standard, which are 83.3%, 80%, 93.3% and 80, respectively. Row 9 shows the accumulated difference from the calibration standard, which adds up to −63.4%. Row 10 shows the consequent expectation value for the amount of scale formation that would occur in the water processing facility from a cubic meter of water having the physical properties stated above, namely 300 ppm total hardness and 200 ppm alkali hardness and 7 pH and 20 degrees Celsius, wherein said facility is operating at a normalized water throughput condition, which is for Example 3 the value of 0.2*0.366=0.0732 gr/M3. The last row in column D, row 11, shows the consequent result of the target value, which is R=10*0.0732=0.732 gr/M3.

TABLE 1

| | | A | B | C | D |
|---|---|---|---|---|---|
| | | Units | Example 1 | Example 2 | Example 3 |
| 1 | Total hardness H | PPM | 360 | 420 | 300 |
| 2 | % of standard | | 100 | 116.7 | 83.3 |
| 3 | Alkalinity | PPM | 250 | 300 | 200 |
| | hardness A | | | | |
| 4 | % of standard | | 100 | 120 | 80 |
| 5 | Ph P | | 7.5 | 8 | 7 |
| 6 | % of standard | | 100 | 106.7 | 93.3 |
| 7 | Temperature T | Degrees C | 25 | 30 | 20 |
| 8 | % of standard | | 100 | 120 | 80 |
| 10 | % change | | 0 | 63.4 | −63.4 |
| 9 | Scale formed | gram/m3 | 0.2 | 0.327 | 0.073 |
| 11 | Scale to be removed | gram/m3 | 2 | 3.267 | 0.733 |

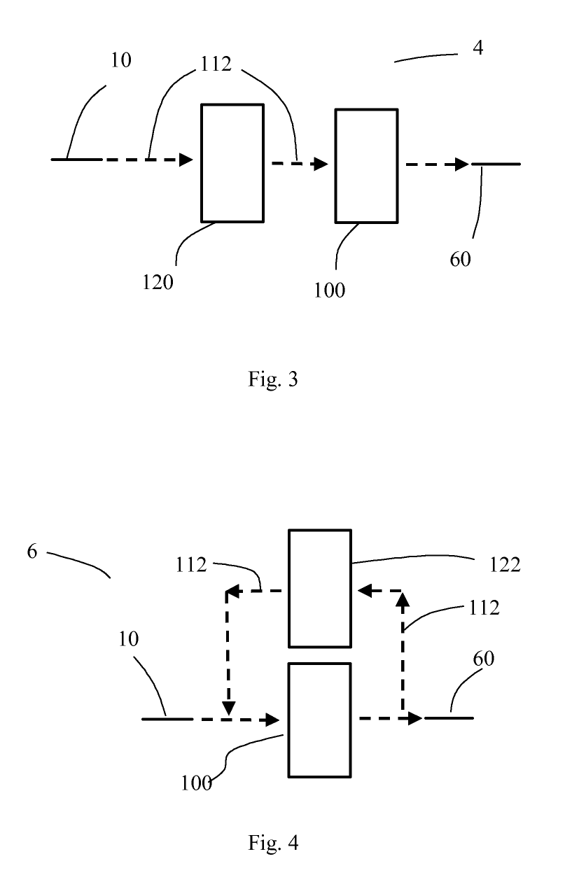

FIG. 3 depicts a schematic diagram of a water processing system 4 according to some embodiments of the present disclosure. System 4 has an inlet 10 where raw water enters system 4, and an outlet 60 where processed water exit system 4. System 4 further comprises a water processing facility 100, functionally associated with outlet 60, for manipulating the water. Such manipulation is for example purification of the water e.g. by filtering or by reverse osmosis process. Other examples for manipulation of the water by water processing facility 100 are heating the water e.g. by an electric heating element or cooling the water e.g. by an evaporator, and the like.

System 4 further may alternatively be characterized as including a device that comprises a water flow through conduit 112 functionally associated with inlet 10 and with water processing facility 100. Water flow through conduit 112 comprises an active electrochemical altering element 120 for removing a quantity of about R scale from each cubic meter of water just prior to entry of the water into water processing facility 100. The target value R is calculated according to R=10*S*[1+((H−360)/360)+((A−250)/250)+((P−7.5)/7.5)+((C−25)/25)], where: the physical properties total hardness (H) ppm, alkali hardness (A) ppm, pH (P), and temperature (C) Celsius are metrics substantially equivalent to actual values for these respective physical properties for water entering conduit 112; and (S) g/M3 is an amount of scale formation that would occur in water processing facility 100 if it were directly accepting a standardized cubic meter of water having 360 ppm total hardness and 250 ppm alkali hardness and 7.5 pH and at 25 degrees Celsius, wherein facility 100 is operating at a normalized water throughput condition.

Anticipating further implementations of the instant invention, FIG. 4 depicts a schematic diagram of a water processing system 6, implementing a further embodiment. Water processing system 6 comprises an inlet 10 where raw water enters system 6, an outlet 60 where processed water exit system 6, and a water processing facility 100 for manipulating the water, water processing facility 100 being functionally associated with outlet 60.

Water processing system further comprises a water flow through conduit 112 functionally associated with inlet 10 and with water processing facility 100. Water flow through conduit 112 comprises an active electrochemical altering element 122 for removing a quantity of about R scale from each cubic meter of water just prior to entry of the water into water processing facility 100. It should be understood that in the embodiment of FIG. 4 element 122 alters water which is circulating through water processing facility 100, substantially by removing a prescribed amount of scale from the water flowing through flow through conduit 112. By mixing the water from inlet 10 with the water from conduit 112 just prior to water processing facility 100, removing a quantity of about R scale from each cubic meter of water just prior to entry of the water into water processing facility 100 is achieved.

The portion of scale constituents to be removed in the treatment step depends on many parameters of the purification system and of the raw water. Parameters of the purification system that may have an effect on this portion are for example the size of the membranes, residence time of the water in the membrane and velocities in and out of the membranes. Parameters of the raw water that may have an effect on this portion are for example the water composition such as total hardness, calcium hardness and concentration of chloride, silica and metals; additional water characteristics are electrical conductivity, pH and water temperature. Because of the great complexity of the dependency of the required portion on a large number of parameters, this portion is found empirically for a number of cases, and can further be calculated for scale-up systems etc.

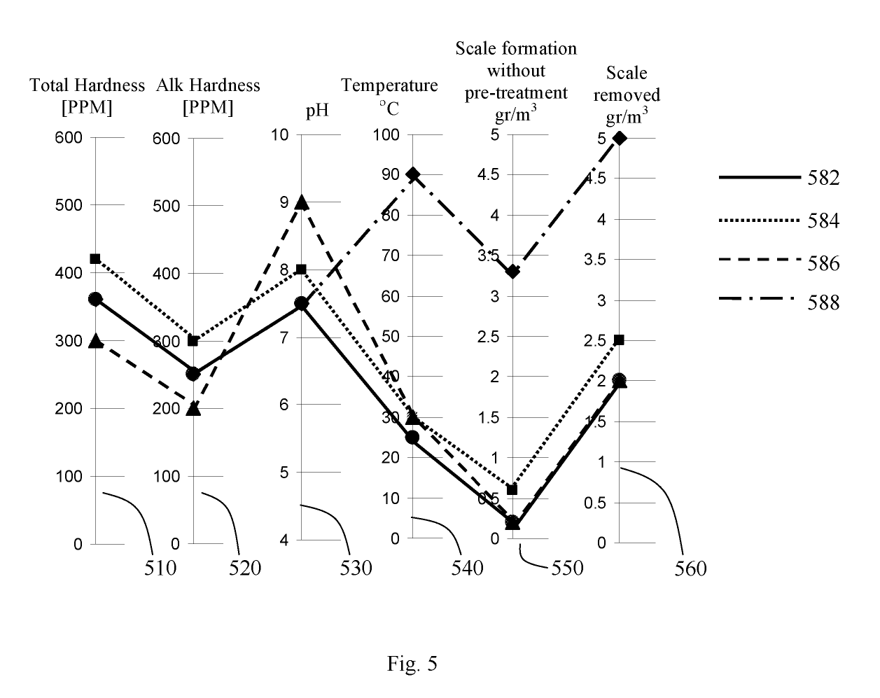

FIG. 5 shows a chart displaying the dependency of scale formation and portion of removed scale, on various system and water parameters for exemplary four cases (graphs 582, 584, 586 and 588). The system has an RO unit with residence time of about 30 seconds, a cooling tower with residence time of about 20 minutes for a single cycle, and a boiler with residence time of about 10 minutes for a single cycle. Axis 510 shows the water total hardness; namely total contents of Ca, and to a lesser extent, Mg and other poorly dissolved metals. Axis 520 shows the alkalinity hardness of the water, namely the contents of dissolved acceptors as CO₃, CO₂, OH— and H ions. Axes 530 and 540 show the pH and temperature of the water, respectively.

Axis 550 shows the amount of scale formed on the RO membranes if no treatment for scale removal is activated. Axis 560 shows the scale that is to be removed by a scale removal treatment, in order to eliminate the formation of scale in the RO membranes. Thus in a case represented by graph 582 (continues line), total hardness of the water is 360 PPM (axis 510), alkalinity hardness is 250 PPM (axis 520), the pH is 7.5 (axis 530) and water temperature is 25° C. (axis 540). Under these conditions, an amount of 0.2 gr of scale per each cubic meter of water that pass the RO membranes is formed on the RO membranes (axis 550). The point of graph 582 on axis 560 shows that elimination of scale formation on the RO membranes is achieved by the removal of 2 gr of scale per cubic meter of water, by a scale remover in treatment prior to the RO step.

Graph 584 (dotted line) represents a case of water with higher hardness, pH and temperature: total hardness of 520 PPM (axis 510), alkalinity hardness of 300 PPM (axis 520), pH of 8 (axis 530) and temperature of 30° C. (axis 540). Under these conditions the amount of scale formed on the RO membranes without scale removal treatment is 0.6 gr per each cubic meter of water flowing pass the RO membranes (axis 550). Subsequently, removal of 2.5 gr of scale per each cubic meter of water (axis 560), in a scale removal treatment process, eliminates the formation of scale.

Graph 586 (dashed line) represents a case with lower hardness and higher pH: The total hardness of water in this case (axis 510) is 300 PPM and alkalinity hardness (axis 520) is 200 PPM. The pH (axis 530) is 9 and temperature (axis 540) is 30° C. Under these conditions 0.2 gr of scale per cubic meter of water is formed on the RO membranes if no scale removal is activated, as can be seen on axis 550. When scale removal is activated, a removal 2 gr of scale per each cubic meter of water (as is shown on axis 560), eliminates scale formation.

Graph 588 (dash-dot line) represents a case of high-temperature water at temperature at 90° C., as can be seen on axis 540. Other parameters of the water are total hardness of 360 PPM, alkalinity hardness of 250 PPM and pH of 7.5. Under these conditions 3.3 gr/m³ is accumulated on the RO membranes if no scale removal is activated (axis 550), while removal of 5 gr/m3 by a scale removal treatment (axis 560) eliminates this scale formation.

Finally, it should be appreciated that the present invention teaches a substantially liner correction to water chemistry around the normal values (360 ppm total hardness and 250 ppm alkali hardness and 7.5 pH and at 25 degrees Celsius). The inventor appreciates and anticipates that this simplistic linearity will have nonlinear components as the values for actual water become far from these normal values. Likewise, the inventor appreciates and anticipates that there will be other corrective factors that are preferable for specific water processing facilities and for specific processes herein. Now, while the invention has been described with respect to specific examples including presently preferred modes of carrying out the invention, those skilled in the art will appreciate that there are numerous variations and permutations of the above described method, systems and techniques that fall within the spirit and scope of the invention as set forth in the appended claims.

1. A water treatment method, for substantially eliminating scale buildup in a water processing facility, the method comprising the steps:
(I) accepting a scale formation standard value (S) g/M3 as an amount of scale formation that would occur in the water processing facility from a cubic meter of water having 360 ppm total hardness and 250 ppm alkali hardness and 7.5 pH and at 25 degrees Celsius, wherein said facility is operating at a normalized water throughput condition;
(II) measuring water from a water source for total hardness (H) ppm, alkali hardness (A) ppm, pH (P), and temperature (C) Celsius;
(III) calculating a scale removal target (R) using a formula R=10*S*[1+((H−360)/360)+((A−250)/250)+((P−7.5)/7.5)+((C−25)/25)], wherein said facility is sized as proportional to operating at the normalized water throughput condition; and
(IV) substantially removing a quantity of about R scale from each cubic meter of the water source water just prior to entry of said water into the water processing facility.

2. A water treatment method according to claim 1 wherein accepting includes that the scale formation standard value (S) is 0.2 g/M3, and calculating includes that the water processing facility is a Reverse Osmosis process, the normalized water throughput condition is a water velocity of 1.5 meters per second through 1 meter long osmotic pressure separation tubes respectively of 4 inch diameter.

3. A water treatment method according to claim 1 wherein accepting includes that the scale formation standard value (S) is 0.3 g/M3, and calculating includes that the water processing facility is a Water Cooling process, the normalized water throughput condition is a water velocity of 1.5 meters per second and 300 tons of refrigeration cooling capacity having a 150 M3/hour circulation to achieve a 5 Celsius degree temperature difference.

4. A water treatment method according to claim 1 wherein accepting includes that the scale formation standard value (S) is 0.5 g/M3, and calculating includes that the water processing facility is a Water Heating process, the normalized water throughput condition is a water velocity of 1.5 meters per second and 300,000 Kilo-calories/kg heat capacity for a heating temperature input of 60 Celsius degrees.

5. The water treatment method according to claim 1 wherein measuring total hardness is substantially measuring dissolved calcium.

6. The water treatment method according to claim 1 wherein measuring alkali hardness is substantially measuring dissolved carbonates.

7. The water treatment method according to claim 1 wherein substantially removing a quantity of about R scale from each cubic meter of water is removing from about R/2 to about 5R scale from each cubic meter of water.

8. The water treatment method according to claim 1 wherein removing a quantity of about R scale from each cubic meter of water is removing more than about 0.1% of the dissolved scale albeit less than 10% of the dissolved scale.

9. The water treatment method according to claim 1 wherein removing a quantity of about R scale from each cubic meter of water includes that removing some bio-life using activated chloride is substituted for removing a functionally equivalent part of the R scale.

10. The water treatment method according to claim 1 wherein removing a quantity of about R scale from each cubic meter of water includes that removing some dissolved metals is substituted for removing a functionally equivalent part of the R scale.

11. The water treatment method according to claim 1 wherein removing a quantity of about R scale from each cubic meter of water is by electrolysis.

12. The water treatment method according to claim 1 wherein removing a quantity of about R scale from each cubic meter of water includes electrolysis.

13. A water treatment device, for substantially eliminating scale buildup in a water processing facility, the device comprising a water flow through conduit wherein at least one active electrochemical altering element removes a quantity of about R scale from each cubic meter of water just prior to entry of said water into the water processing facility, such that R=10*S*[1+((H−360)/360)+((A−250)/250)+((P−7.5)/7.5)+((C−25)/25)] and (S) g/M3 is an amount of scale formation that would occur in the water processing facility if it were directly accepting a standardized cubic meter of water having 360 ppm total hardness and 250 ppm alkali hardness and 7.5 pH and at 25 degrees Celsius, wherein said facility is operating at a normalized water throughput condition, and such that physical properties total hardness (H) ppm, alkali hardness (A) ppm, pH (P), and temperature (C) Celsius are metrics substantially equivalent to actual values for these respective physical properties for water entering the conduit.

14. A water treatment method substantially as herein-before described and illustrated and characterized by, just prior to entry of each predetermined quantity of water into a commercial water flow-through processing facility, removing more than about 0.1% of dissolved scale from the water quantity albeit less than 10% of dissolved scale from the water quantity; thereby substantially eliminating scale buildup in the water processing facility.
